(19) United States
(12) Patent Application Publication
(10) Pub. No.: US 2026/0099569 A1
(43) Pub. Date: Apr. 9, 2026

(54) NON-TRANSITORY COMPUTER-READABLE MEDIUM, CALCULATION METHOD, AND INFORMATION PROCESSING DEVICE

(71) Applicant: Fujitsu Limited, Kawasaki-shi (JP)

(72) Inventor: Yuma ICHIKAWA, Kawasaki (JP)

(73) Assignee: Fujitsu Limited, Kawasaki-shi (JP)

(21) Appl. No.: 19/350,096

(22) Filed: Oct. 6, 2025

(30) Foreign Application Priority Data
Oct. 7, 2024 (JP) 2024-175795

(51) Int. Cl. G06F 17/18; G06F 17/16

(52) U.S. Cl. CPC G06F 17/18; G06F 17/16

(57) ABSTRACT

There is provided a non-transitory computer-readable medium storing a calculation program for causing a computer to execute a process. The process includes, an embedding vector generation process for generating an embedding vector that represents each similarity of each problem for multiple problems, in optimization using a continuous relaxation simulated annealing method, which searches for a solution by incorporating continuous relaxation to discrete optimization problems, and a search process for introducing a loss term based on the embedding vector into a loss function in which each element of a matrix obtained by relaxing discrete variables to be optimized into a continuous matrix becomes a discrete optimization problem, and searching for solutions of the multiple problems in parallel.

### CROSS-REFERENCE TO RELATED APPLICATION

This application is based upon and claims the benefit of priority of Japanese Patent Application No. 2024-175795 filed on Oct. 7, 2024, the entire contents of which are incorporated herein by reference.

### FIELD

A certain aspect of the present embodiments relates to a non-transitory computer-readable medium, a calculation method, and an information processing device.

### BACKGROUND

Technologies for optimizing complex combinations have been disclosed (see, for example, Schuetz, M. J., Brubaker, J. K., and Katzgraber, H. G. (2022a). Combinatorial optimization with physics-inspired graph neural networks. Nature Machine Intelligence, 4 (4): 367-377, and Schuetz, M. J., Brubaker, J. K., Zhu, Z., and Katzgraber, H. G. (2022b). Graph coloring with physics-inspired graph neural networks. Physical Review Research, 4(4):043131.)

### SUMMARY

According to an aspect of the present disclosure, there is provided a non-transitory computer-readable medium storing a calculation program for causing a computer to execute a process, the process including: an embedding vector generation process for generating an embedding vector that represents each similarity of each problem for multiple problems, in optimization using a continuous relaxation simulated annealing method, which searches for a solution by incorporating continuous relaxation to discrete optimization problems; and a search process for introducing a loss term based on the embedding vector into a loss function in which each element of a matrix obtained by relaxing discrete variables to be optimized into a continuous matrix becomes a discrete optimization problem, and searching for solutions of the multiple problems in parallel.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF THE DRAWINGS

FIG. 1 illustrates conversion to a graph embedding vector;

FIG. 2 is a conceptual diagram of how a GNN feed-forward pass derives a solution from multiple embeddings;

FIG. 3A is a functional block diagram of an overall configuration of an information processing device according to an embodiment;

FIG. 3B is a hardware configuration diagram of an information processing device;

FIG. 4 is a flowchart of an example of an operation of an information processing device during machine learning; and

FIG. 5 is a flowchart of an example of an operation of an information processing device when outputting an approximate solution to an optimization problem using results of machine learning model.

### DESCRIPTION OF EMBODIMENTS

In combinatorial optimization, it is considered to search for optimal solutions using a continuous relaxation method that uses a machine learning model. However, it is difficult to find solutions for multiple problems.

Optimization problems exist in a variety of industries, including manufacturing and distribution. Combinatorial optimization problems, which involve optimizing combinations, are particularly important in the field of optimization. Combinatorial optimization problems are applied in a variety of fields, including transportation, logistics, communications, or finance.

Combinatorial optimization is an optimization problem formulated as expressed in the following formula (1). In the formula (1), “C” is a parameter that characterizes the problem. Note that in the formula (1), “x” is a vector represented by 0 and 1 and has N elements. Generally, in f(x;A), “x” represents the variable to be optimized, and “A” represents a constant that is not to be optimized. Therefore, in the formula (1), the variable vector x is the variable to be optimized, and the parameter C is a constant.

$$\begin{matrix}[ Formula 1 ] & \\ {min}_{x ∈ {\{ 0 , 1 \}}^{N}} f ( x ; C ) & ( 1 )\end{matrix}$$

In recent years, continuous relaxation methods have been developed as an alternative to discrete optimization problems. The continuous relaxation method is a technique that, instead of solving a discrete optimization problem, relaxes the discrete optimization problem and solves a corresponding continuous optimization problem. A continuous optimization problem can be expressed as in the following formula (2). In the formula (2), [0,1]^{N} represents an N-dimensional hypercubic lattice with values of 0 or 1. In the formula (2), the variable vector p is the variable to be optimized.

$$\begin{matrix}[ Formula 2 ] & \\ {min}_{p ∈ {[ 0 , 1 ]}^{N}} f ( p ; C ) & ( 2 )\end{matrix}$$

However, even with the continuous relaxation method, the loss landscape may still be complex. Furthermore, the relaxed optimal solution may differ significantly from the original optimal solution.

Next, the combination of unsupervised learning and combinatorial optimization in the continuous relaxation method will be described. In this case, the above variable vector p is characterized by a deep neural network (DNN) model, and optimization is performed using the loss function in the following formula (3). In this case, the optimization problem for the continuously relaxed variable p is reduced to optimizing the DNN parameter θ.

$$\begin{matrix}[ Formula 3 ] & \\ {min}_{θ} f ( {p}_{θ} ; C ) & ( 3 )\end{matrix}$$

This optimization method may output a continuous solution. A continuous solution here is a value greater than 0 and less than 1. If a continuous solution is output, it becomes necessary to round the solution to “1” or “0” using thresholding, for example, by setting values greater than ½ to “1” and values less than ½ to “0”. Furthermore, even with a greedy algorithm, solving the problem becomes difficult once the region where a good solution can be obtained is exceeded. Transfer learning is also difficult.

To address this issue, it is possible to introduce a penalty term into the cost function, as expressed in the following formula (4). The penalty term is part of the following formula (5) and is a loss term used to control the degree of continuity and discreteness.

$$\begin{matrix}[ Formula 4 ] & \\ \hat{r} ( θ ) = f ( {p}_{θ} ; C ) + λ {\sum }_{i = 1}^{N} ( {( 2 {p}_{θ , i} - 1 )}^{2} - 1 ) & ( 4 )\end{matrix}$$

$$\begin{matrix}[ Formula 5 ] & \\ {\sum }_{i = 1}^{N} ( {( 2 {p}_{θ , i} - 1 )}^{2} - 1 ) & ( 5 )\end{matrix}$$

“λ” is a parameter that controls the penalty term in the formula (5), and is a hyperparameter that controls the degree of continuity and discreteness. For example, if λ<0, continuous solutions are preferred, and if 2>0, discrete solutions are preferred.

As machine learning progresses, the hyperparameter λ is gradually changed from a negative value λ(0)<0 to a positive value λ(T)>0. As a result, the penalty term changes from one that reduces loss the more continuous the discrete vector p is to one that increases loss the more continuous the discrete vector p is. For example, if λ is −∞, the output solution will be ½. If λ is +∞, the output solution will be a discrete variable of 0 or 1. This method is sometimes called continuous relaxation simulated annealing method. By controlling in this way, machine learning ends when the discrete vector becomes mostly discrete.

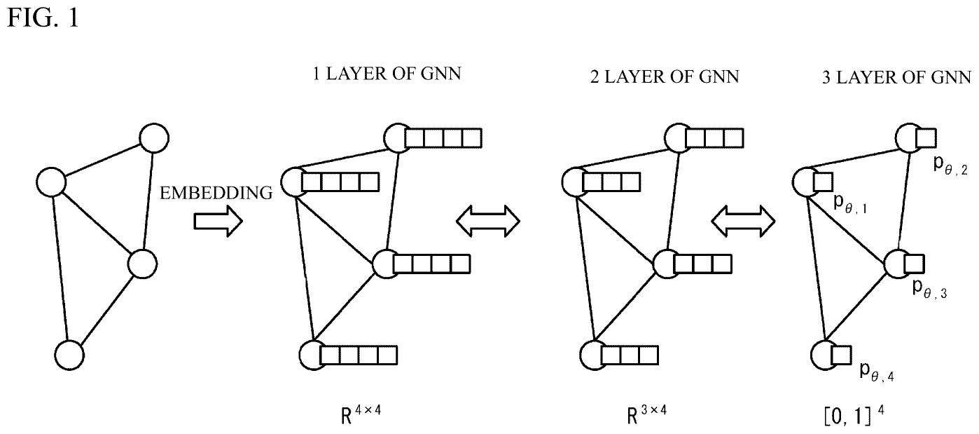

Here, an example of optimizing a variable vector p by parametrizing the vector using a GNN (Graph Neural Network). In this optimization, the graph G of the optimization problem is converted into an embedding vector h⁽⁰⁾(G). “G” is the graph's feature vector in the GNN. For a combinatorial optimization problem on the graph G, the GNN is used to characterize the relaxation variable p as p_{θ}(h⁽⁰⁾(G);G). For example, in FIG. 1, the graph's feature vector G is converted into a graph embedding vector with N=4 nodes and E=4 edges. The following formula (6) is the embedding vector that characterizes the graph G. Note that embedding refers to converting the nodes into real vectors.

$$\begin{matrix}[ Formula 6 ] & \\ {h}^{( 0 )} ∈ & ( 6 )\end{matrix}$$

Specifically, when the graph G is given, embedding is performed using the feature vector G. The embedded result corresponds to a real vector. In the example in FIG. 1, [0, 1]⁴ is a real vector. This real vector is gradually converted to one dimension, and a network is constructed to obtain the optimal optimization solution in the final layer.

However, the optimization method using the above-mentioned continuous relaxation simulated annealing method outputs one solution when a problem example is given, making it difficult to find solutions for multiple problems.

In the following example, an embodiment in which solutions to multiple problems can be found will be given.

### Embodiment

First, the principle of this embodiment will be given. In this embodiment, an Annealing Hopfield GNN, which outputs solutions to corresponding problems based on initial values, similar to a Hopfield Neural Network will be described.

For simplicity, a combinatorial optimization problem on a graph will be given. First, collect S problems on a graph. Next, for a set of S problem instances of the graph G as expressed in the following formula (7), create an embedding vector set (the following formula (8)) that reflects the similarity between the problem instance sets. The embedding vector hᵢ⁽⁰⁾ is a vector that reflects the structure of the graph G. An embedding vector set is a vector set in which, when graphs Gᵢ and Gⱼ are similar, the embedding vector hᵢ⁽⁰⁾ corresponding to graph Gᵢ and the embedding vector hⱼ⁽⁰⁾ corresponding to graph Gⱼ are similar. For example, the higher the similarity between the graphs Gᵢ and Gⱼ, the larger the inner product of the embedding vector hᵢ⁽⁰⁾ and the embedding vector hⱼ⁽⁰⁾. Conversely, the lower the similarity between the graphs Gᵢ and Gⱼ, the smaller the inner product of the embedding vector hᵢ⁽⁰⁾ and the embedding vector hⱼ⁽⁰⁾.

$$\begin{matrix}[ Formula 7 ] & \\ {𝒢}_{S} = {\{ {G}_{S} \}}_{s = 1}^{S} & ( 7 )\end{matrix}$$

$$\begin{matrix}[ Formula 8 ] & \\ {H}_{S}^{( 0 )} = \{ {h}_{S}^{( 0 )} \} & ( 8 )\end{matrix}$$

The GNN is minimized using the loss function of the following formula (9). The loss function of the following formula (9) searches for a solution that minimizes the sum of the formula (4) from the first problem instance to the S-th problem instance.

$$\begin{matrix}[ Formula 9 ] & \\ \hat{r} ( θ ) = {\sum }_{s = 1}^{S} \{ f ( {p}_{θ} ( {h}_{s}^{( 0 )} ( {G}_{S} ) ) ; {G}_{S} ) + λ {\sum }_{i = 1}^{N} ( {( 2 {p}_{θ , i} ( {h}_{s}^{( 0 )} ) - 1 )}^{2} - 1 ) \} & ( 9 )\end{matrix}$$

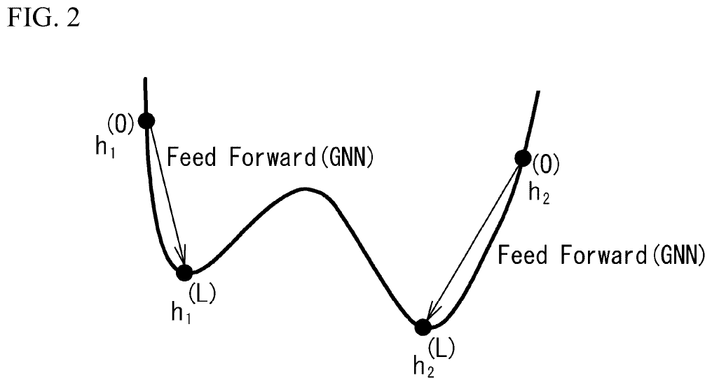

FIG. 2 is a conceptual diagram of how a GNN retrieves a solution from multiple embeddings using a feed-forward pass. As illustrated in FIG. 2, a solution is searched for that minimizes the cost function for each of s=1 to S.

Next, the above solution principle will be verified. Specifically, the weighted MaxCut problem on a Random Regular Graph with degree d=20 and 100 nodes will be verified. A degree of d=20 and 100 nodes means that there are 100 nodes, with each node randomly connected to 20 other nodes. In the following formula (10), Aᵢⱼ represents the weighted adjacency matrix. The weights are generated uniformly and randomly from [−1, 1, 3].

$$\begin{matrix}[ Formula 10 ] & \\ f ( x ; G ) = {\sum }_{i < j} {A}_{ij} ( 2 {x}_{i} {x}_{j} - {x}_{i} - {x}_{j} ) & ( 10 )\end{matrix}$$

Since the adjacency matrix Aₛ represents each problem, the adjacency matrix Aₛ is unified to create aₛ=flatten (As). To reduce the amount of calculation, an autoencoder is used to compress the following formula (11) into the following formula (12), optimizing the loss for multiple problems. Furthermore, S=3, and there are three instances.

$$\begin{matrix}[ Formula 11 ] & \\ {S}_{} = {\{ {a}_{S} \}}_{s = 1}^{S} ∈ & ( 11 )\end{matrix}$$

$$\begin{matrix}[ Formula 12 ] & \\ = {\{ {h}_{s}^{( 0 )} \}}_{s = 1}^{S} ∈ & ( 12 )\end{matrix}$$

For each of the three instances, the solution x₁ₛₕₒₜ obtained using the optimization solution method based on the continuous relaxation simulated annealing method is evaluated using the following formula (13).

$$\begin{matrix}[ Formula 13 ] & \\ ApR = \frac{f ( {x}_{hopfield} ; {C}_{S} )}{f ( {x}_{1 shot} ; {C}_{S} )} & ( 13 )\end{matrix}$$

Table 1 shows the results of ApR. Unlike the simultaneous solution of multiple combinatorial optimization problems using matrix relaxation, it is confirmed that multiple problems can be solved without unnecessary parameter increases.

TABLE 1

| | C₁ | C₂ | C₃ |
|---|---|---|---|
| ApR | 0.999 | 0.998 | 0.983 |

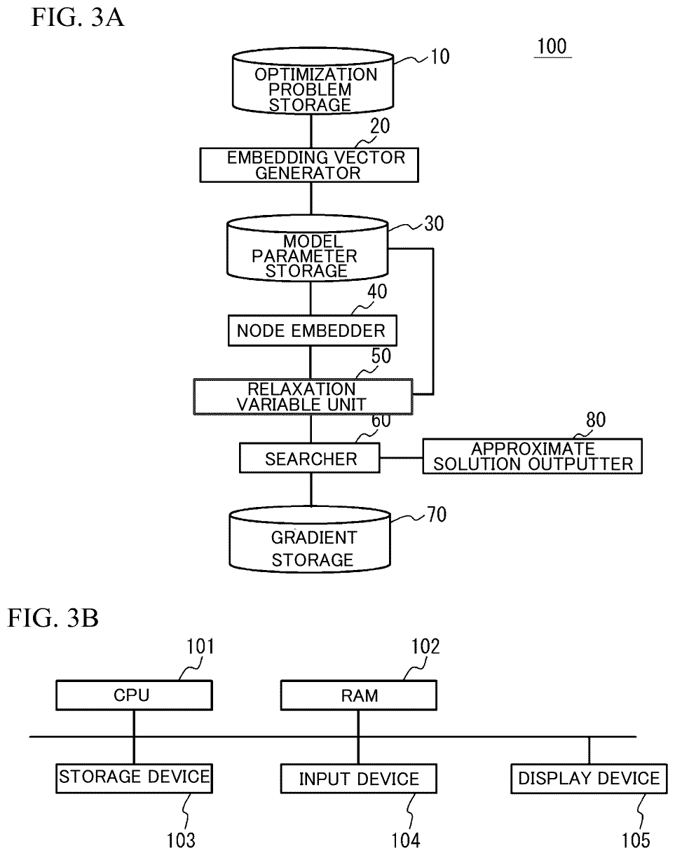

Next, the device configuration for implementing the above solution principle will be given. FIG. 3A is a functional block diagram of the overall configuration of an information processing device 100 according to the embodiment. The information processing device 100 is, for example, a server for optimization processing. As illustrated in FIG. 3A, the information processing device 100 functions as an optimization problem storage 10, an embedding vector generator 20, a model parameter storage 30, a node embedder 40, a relaxation variable unit 50, a searcher 60, a gradient storage 70, an approximate solution outputter 80 and so on. The information processing device 100 functions as a machine learning device during machine learning, and as a determination device during determination.

FIG. 3B is a hardware configuration diagram of the information processing device 100. As illustrated in FIG. 3B, the information processing device 100 includes a CPU 101, a RAM 102, a storage device 103, an input device 104, a display device 105, and the like.

The CPU 101 is a central processing unit. The CPU 101 includes one or more cores. The RAM (Random Access Memory) 102 is a volatile memory that temporarily stores the program executed by the CPU 101 and the data processed by the CPU 101. The storage device 103 is a non-volatile storage device. For example, a ROM (Read Only Memory), a solid state drive (SSD) such as a flash memory, or a hard disk driven by a hard disk drive can be used as the storage device 103. The storage device 103 stores a machine learning program and a determination program. The input device 104 is a device for a user to input necessary information, such as a keyboard or a mouse. The display device 105 is a display device that displays the sampling results output by the approximate solution outputter 80 on a screen. Each part of the information processing device 100 is realized by the CPU 101 executing the calculation program or the machine learning program. Note that each part of the information processing device 100 may be hardware such as a dedicated circuit.

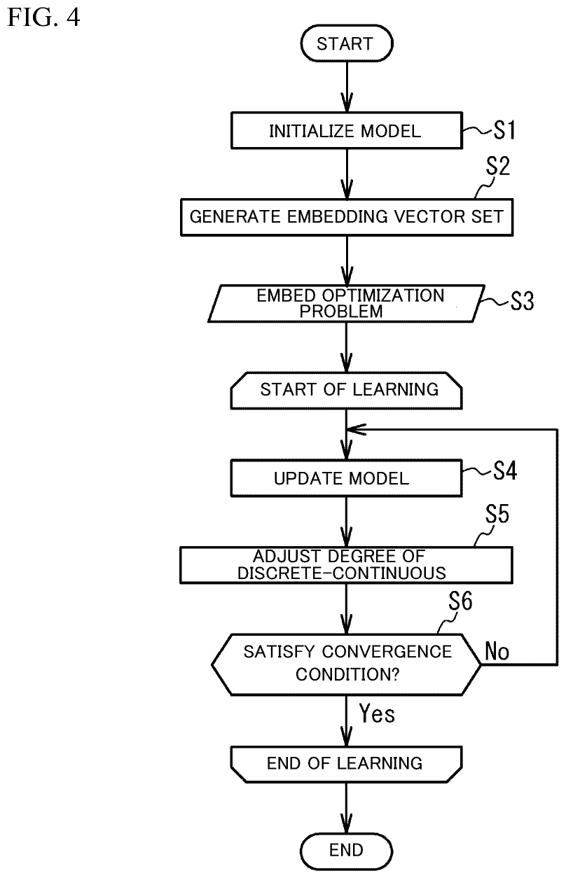

FIG. 4 is a flowchart illustrating an example of the operation of the information processing device 100 during machine learning. As illustrated in FIG. 4, the searcher 60 initializes the model (step S1). Specifically, the searcher 60 sets the model parameters stored in the model parameter storage 30 to predetermined initial values.

Next, the embedding vector generator 20 generates an embedding vector for each of the multiple problems stored in the optimization problem storage 10, thereby generating a set of embedding vectors represented by the above formula (8) (step S2).

Next, the node embedder 40 embeds the optimization problem (step S3). This results in the loss function represented by the above formula (9).

Next, the searcher 60 updates the model parameters using the gradient method (step S4). The model parameters are updated using the gradient stored in the gradient storage 70. The first time step S4 is executed, the model parameters are not updated.

Next, the searcher 60 adjusts the degree of continuity and discreteness (step S5). Specifically, each time step S5 is repeated, the searcher 60 gradually changes the hyperparameter λ in the formula (9) above from a negative value λ(0)<0 to a positive value λ(T)>0, and calculates the loss function.

Next, the searcher 60 determines whether the convergence condition is met (step S6). For example, it determines whether the loss function in the formula (9) above no longer becomes smaller than a specified value, even after step S5 is repeatedly executed. If the determination in step S6 is “No,” the process is repeated from step S4.

If step S6 returns “Yes,” execution of the flowchart ends. In this case, the model parameter storage 30 stores the model parameters that minimize the loss function.

The machine learning illustrated in FIG. 4 results in a machine learning model that minimizes the loss function of the formula (9). The machine learning model (model parameters) is stored in the model parameter storage 30.

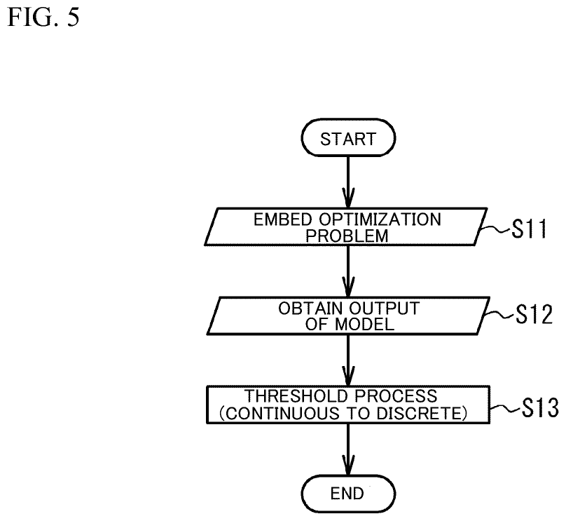

FIG. 5 is a flowchart illustrating an example of the operation of the information processing device 100 when outputting an approximate solution to an optimization problem using the results of the machine learning model obtained by the machine learning illustrated in FIG. 4. As illustrated in FIG. 5, the node embedder 40 embeds the optimization problem (step S11).

Next, the approximate solution outputter 80 obtains the output of the machine learning model (step S12).

Next, the approximate solution outputter 80 performs threshold processing on the optimal solution output by the machine learning model (step S13). For example, a threshold is set for each value output by the machine learning model and binarized. For example, when converting each value into two values, 0 and 1, the threshold is set to 0.5, and values greater than 0.5 are set to 1, and values less than 0.5 are set to 0.

In the above embodiment, an optimization problem using a graph as the optimization target is described. Optimization problems using a graph are not particularly limited, but an example would be an energy transportation problem. The above example can also be applied to optimization problems that do not use a graph as the optimization target. Optimization problems that do not use a graph are also not particularly limited, but an example would be a corporate scheduling problem.

In the above embodiment, the embedding vector generator 20 is an example of an embedding vector generator that generates embedding vectors representing the similarity between multiple problems in optimization using the continuous relaxation simulated annealing method, which performs a search by incorporating continuous relaxation into a discrete optimization problem. The searcher 60 introduces a loss term based on an embedding vector into a loss function in which each element of a matrix obtained by relaxing the discrete variables to be optimized into a continuous matrix becomes a discrete optimization problem, and this is an example of a searcher that searches for solutions to multiple problems in parallel.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A non-transitory computer-readable medium storing a calculation program for causing a computer to execute a process, the process comprising:
an embedding vector generation process for generating an embedding vector that represents each similarity of each problem for multiple problems, in optimization using a continuous relaxation simulated annealing method, which searches for a solution by incorporating continuous relaxation to discrete optimization problems; and
a search process for introducing a loss term based on the embedding vector into a loss function in which each element of a matrix obtained by relaxing discrete variables to be optimized into a continuous matrix becomes a discrete optimization problem, and searching for solutions of the multiple problems in parallel.

2. The non-transitory computer-readable medium according to claim 1,
wherein the loss term is changed as the search process progresses.

3. The non-transitory computer-readable medium according to claim 1,
wherein, as the search process progresses, the loss term is changed from one that results in smaller losses the more continuous variable, to one that results in larger losses the more continuous the variable.

4. A calculation method implemented by a computer, the method comprising:
an embedding vector generation process for generating an embedding vector that represents each similarity of each problem for multiple problems, in optimization using a continuous relaxation simulated annealing method, which searches for a solution by incorporating continuous relaxation to discrete optimization problems; and
a search process for introducing a loss term based on the embedding vector into a loss function in which each element of a matrix obtained by relaxing discrete variables to be optimized into a continuous matrix becomes a discrete optimization problem, and searching for solutions of the multiple problems in parallel.

5. The method according to claim 4,
wherein the loss term is changed as the search process progresses.

6. The method according to claim 4,
wherein, as the search process progresses, the loss term is changed from one that results in smaller losses the more continuous variable, to one that results in larger losses the more continuous the variable.

7. An information processing device comprising:
a memory; and
a processor coupled to the memory and the processor configured to execute a process, the process comprising:
an embedding vector generation process for generating an embedding vector that represents each similarity of each problem for multiple problems, in optimization using a continuous relaxation simulated annealing method, which searches for a solution by incorporating continuous relaxation to discrete optimization problems; and
a search process for introducing a loss term based on the embedding vector into a loss function in which each element of a matrix obtained by relaxing discrete variables to be optimized into a continuous matrix becomes a discrete optimization problem, and searching for solutions of the multiple problems in parallel.

8. The information processing device according to claim 7,
wherein the loss term is changed as the search process progresses.

9. The information processing device according to claim 7,
wherein, as the search process progresses, the loss term is changed from one that results in smaller losses the more continuous variable, to one that results in larger losses the more continuous the variable.
